(19) United States
(12) Patent Application Publication
(10) Pub. No.: US 2004/0267615 A1
(43) Pub. Date: Dec. 30, 2004

(54) Advertising system and method

(76) Inventor: Len Rothbaum, Wilsonville, OR (US)

Correspondence Address: DELLETT AND WALTERS, P. O. BOX 2786, PORTLAND, OR, 97208-2786, US

(21) Appl. No.: 10/828,506

(22) Filed: Apr. 19, 2004

Related U.S. Application Data
(60) Provisional application No. 60/463,888, filed on Apr. 18, 2003.

(51) Int. Cl. G06F 17/60; H04M 15/00

(52) U.S. Cl. 705/14

(57) ABSTRACT

A system and method of presenting advertising to a consumer employs use of telephone calls, whether accessed by toll-free number, by use of calling cards or service access cards or other account access mode. When a user makes a call, attempts access to the service, to access an account, or to use the calling card, and advertisement is presented to the user prior to allowing access to the service, prior to allowing access to the account or prior to connecting the telephone call. The user is encouraged to listen to the ad in exchange for a free telephone call service or for entry into a game of chance such as a winning number drawing.

### BACKGROUND OF THE INVENTION

This invention relates to accounts, prepaid service, post-paid service, prepaid and value added cards, telecommunication cards, telephone cards and advertising and the like, and more specifically to a system and method of providing advertising to consumers and to the system and method of encouraging consumers to access the advertising.

Advertisers and vendors of advertising time need effective ways to get their ads presented to consumers, and are interested in ways to reach an individual, to inform the individual of the advertiser's services or products.

Consumers who would interact by phone, direct, computer, POSA terminals or sales terminal, represent a large audience to which marketing can be directed but which has heretofore been largely ignored.

### SUMMARY OF THE INVENTION

In accordance with the invention, an advertising system and method presents advertising to consumers, account holders such as telephone customers, phone card users of cards provided by IXCs (Inter-exchange Carriers), prepaid phone card users, value added card users, ATM and credit/debit card users and non-account holding consumers. A user is provided with a telephone number (typically a toll free number) to call and an advertisement can be presented to the user in the time period after the user has dialed the call, but before the call proceeds.

Accordingly, it is an object of the present invention to provide an improved system and method of advertising to consumers.

It is also an object of the present invention to provide an improved system and method of advertising over the telephone.

Another object of the invention is to provide a system and method of presenting advertising to value added card holders.

It is a further object of the present invention to provide an improved system and method of providing advertising and other information to users of prepaid phone cards, gift cards, and the like.

It is yet another object of the present invention to provide an improved method and system of advertising.

It is a further object of the present invention to provide a three-in-one or more prepaid card.

It is a further object of the present invention to provide a multiple card phone card or prepaid goods/services card configuration.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a view of a front side of a three-in-one prepaid card as employable herein;

FIG. 2 is a view of a back side of a three-in-one prepaid card as employable herein;

FIG. 3 is a diagram illustrating operation of a prepaid calling card advertising system and method according to the invention;

FIG. 4 is a view of an operational flow according to the system when a mode of end-user with service provider IVR capabilities is employed;

FIG. 5 is a view of an operational flow according to the system when a mode of end-user without service provider IVR capabilities is employed;

FIG. 6. is a flow chart of the steps of operation of a local services aspect in accordance with the invention;

FIG. 7 is a flow chart of the steps of operation of a direct services aspect in accordance with the invention;

FIG. 8 is a flow chart of the steps of operation of a free call service aspect in accordance with the invention;

FIG. 9 is a view of one side of a preferred card in accordance with the invention; and

FIG. 10 is a view of the opposite side of the card of FIG. 9.

### DETAILED DESCRIPTION

The system according to a preferred embodiment of the present invention comprises a system and method that provides advertising to consumers over a telephone call in an interval before the call is connected or otherwise continued.

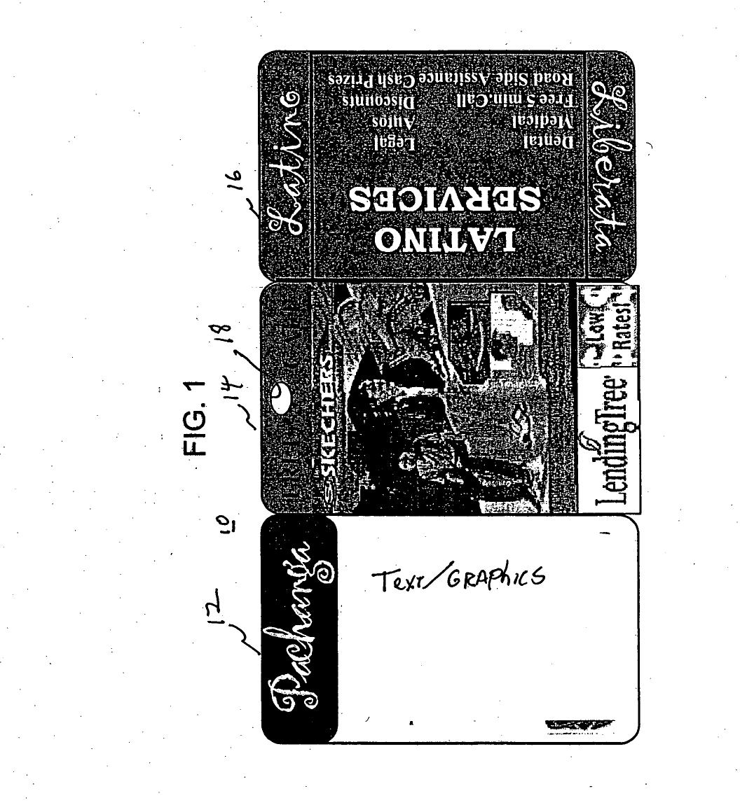

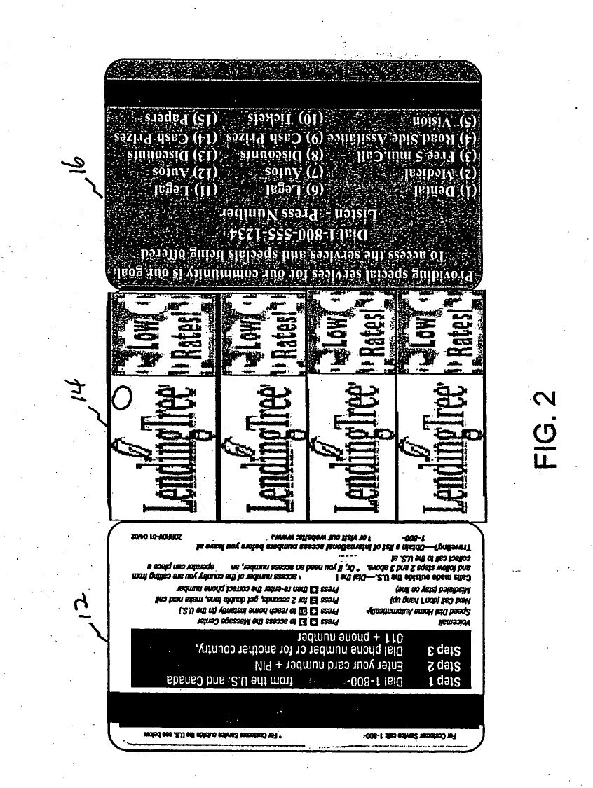

Referring to FIG. 1 and FIG. 2, views of the front and back sides, respectively, of a three-in-one prepaid card as employable herein, a card 10 is comprised of 3 separate cards 12, 14 and 16, suitably joined in a separable manner. Card 12 is preferably a pre-paid telephone card, for example, while card 14 as a free call card having advertising thereon, and card 16 is a services card which provides a link to specific services vendors, for example. The center card 14 includes an opening 18 therein, so as to enable the 3 card configuration to be hung on a point of sales rack, for example. The calling card 12 may include text or graphics on the front, which can be the name of the party selling or promoting the card. Card 14 includes several advertisements thereon. Card 16 lists a number of available services which can be accessed by use of the card, including dental, medical, legal, automobile sales/services, discount services, road side assistance, directions, tickets, translation services, job assistance, conferences, access to prize give-aways, etc. The card includes a free call in the illustrated example, to encourage its use by the consumer.

FIG. 2 illustrates the reverse of the 3 cards, wherein the back of calling card 12 includes instructions for use of the various calling card functions, as well as the access numbers to dial for different options. The back of card 14 includes more advertising, while the back of card 16 gives an access number to reach the services defined thereon, and instructions on how to select the various options. It may be noted that additional options include purchasing tickets, papers, vision care, for example. There may be more than one option shown for similar services, in the illustrated example there are 2 numbers listed each for the legal, autos, discounts and cash prizes options.

The services card will connect the user with specific service providers for the particular type of service selected. Accordingly, the broker of the card can sell placement to service providers, whereby when a user phones the access number and selects a particular type of service, the user is routed to the service provider. Thus the card broker is able to sell the service provider a type of advertising placement or customer access.

The cards can be set for specific types of users, such as a travel related card having services that would be of use or interest to traveling persons or families. Another type of card can be packaged to include services that gamblers might use.

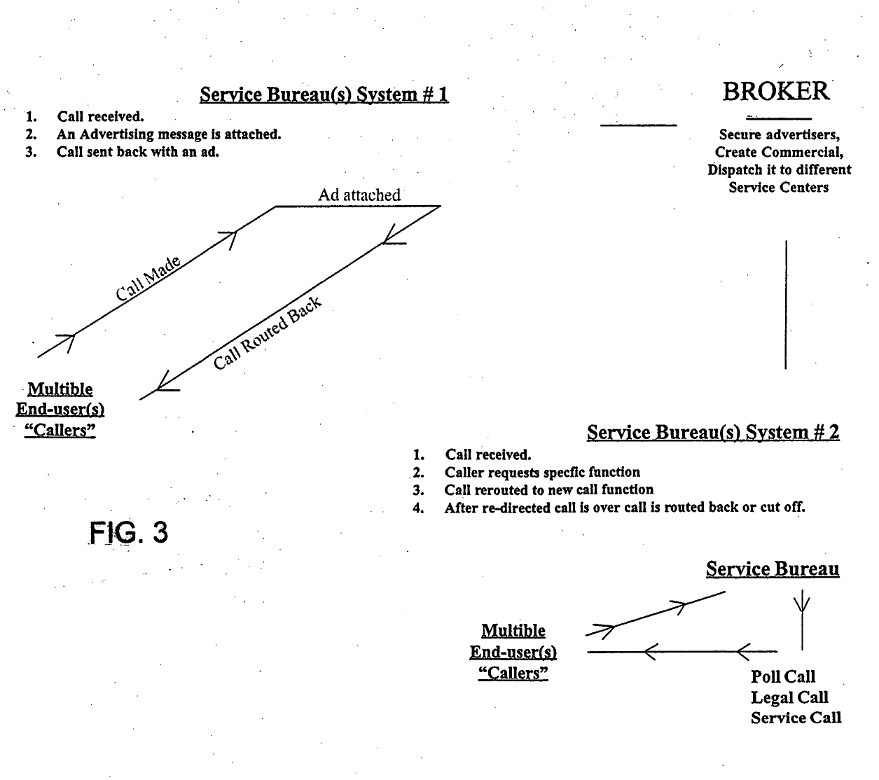

Referring now to FIG. 3, a diagram illustrating a first manner of operation of a prepaid calling card advertising system and method according to the invention, when a user makes a call using the prepaid card (for example, card 12 of FIG. 1), the end user calls an access number, and enters the card number. Then, the system according to the invention will embed or attach an advertisement (“Ad attached”), and the advertisement is played to the caller (“Call Routed Back”). This advertisement may comprise a 15, 30, 45 or 60 (or more) second ad, for example, or may be a public service announcement. Additionally, it may comprise a short poll or survey, wherein the user can answer by use of telephone tone pads, or by voice. Once the advertisement or other message/poll is completed, the user's call is then continued, connecting the user to the desired telephone call.

According to an alternative system, as further illustrated in FIG. 3, denoted Services Bureau(s) System #2, in this system a call is received from the end user, and the caller requests a specific function. This function can comprise, for example, the various services listed above in connection with card 16, for example. It may also comprise a polling call, whereby the user's opinion is polled, or a service call asking for legal services (access to legal representation, bail bonding, etc.). The user's call is then routed to the specific service provider, and after the call is over, may be re-directed to another function or disconnected.

The system and method can also be employed with non-card type accounts, for example, telephone accounts, where the account holder may be billed for services or goods after they are provided. Also, the system can be provided to non-account holding consumers, who have no prior relation or no account based relationship with the advertiser or the provider of the system and method herein

In the above examples, the broker shown in the FIG. 3 sells the advertising that is provided in any of the call situations. The broker also can create the commercial ads that are played, and routes the ads to services centers which will handle the actual telephone calls.

The system enables the combination of geographically defined spot ad placement, the ability to know exactly where, when and how many calls are made and heard by the consumer. This can be accomplished in the preferred embodiment by using monitored toll free access numbers that are specific to a designated area. The system also provides the ability to use existing radio commercials for example, using the commercials an advertising is already playing, which quick changes in the messages to be played by electronic transfer of an audio file (such as MP3 files, for example). The system also provides an ultra captive audience (the phone card users must listen to and wait for the ads to be completed before their calls will go through). The system also enables detailed reporting of how many users have listened to the ads, which translates into new levels of effectiveness in advertising.

Geographically defined spot placement is provided through partnerships with phone cards vendors and distributors, allowing the knowledge of exactly what cards are sold and where. Then, using toll free access numbers that are specific to phone cards sold in a particular market area, the broker can play a local advertiser's message to a local audience, for example.

Existing radio commercials can be used. The advertising played can be the same 15 second, 30 second, and 60 second audio commercials that an advertiser is already playing on radio stations. These are merely example lengths, being typical standard length ads currently in use. Other lengths may be employed. Alternatively, the broker can provide production studios to prepare the ads. When ad copy changes in another media, so can the copy played to the card users. The ads played by the system can be quickly modified or updated by sending an MP3 audio file of an advertising commercial and uploading it into the system.

The system provides a captive audience, as callers must listen to the commercial before their call is connected, and the ads are being played directly into the caller's ear. Never before has there been an advertising medium that can get into the mind of the consumer quicker.

The system also enables detailed reporting, generating detailed reports that will confirm when each advertisement was played to incoming callers.

While the illustrated example of the system and method employs pre-paid phone cards, other non-telephone cards can be employed, including, in addition to prepaid long distance, prepaid wireless, prepaid local dial tone and prepaid internet, gift cards, debit/credit cards, promotional cards, prepaid merchandise cards (e.g., prescriptions, groceries, coffee, gasoline, etc.), prepaid services cards (dental, legal, travel, road side assistance, restaurant services, check services, entertainment including, for example, satellite TV). With each of these various types of cards, when the card is used, an advertisement can be presented to the user, either in print (such as with a receipt showing the amount of the transaction) or other manner (ad plays on ATM screen, or TV screen, or cell phone display screen, for example). Further, the system may be employed without use of cards, by advertising bill boards, or other ads, where a consumer is directed to call a telephone number to access the service.

The system can perform in a number of ways. First, a direct branding (prepaid phone cards) mode wherein a simple message is played. In this mode, the user dials a number, gets the message played, then inputs the PIN and has the call connected. A second mode, IVR (Interactive voice response) mode, accounts for tracking, which message is desired to be played, etc. In the IVR mode, the user dials, puts in the PIN, hears the message, and then is connected to whatever service or provider is appropriate.

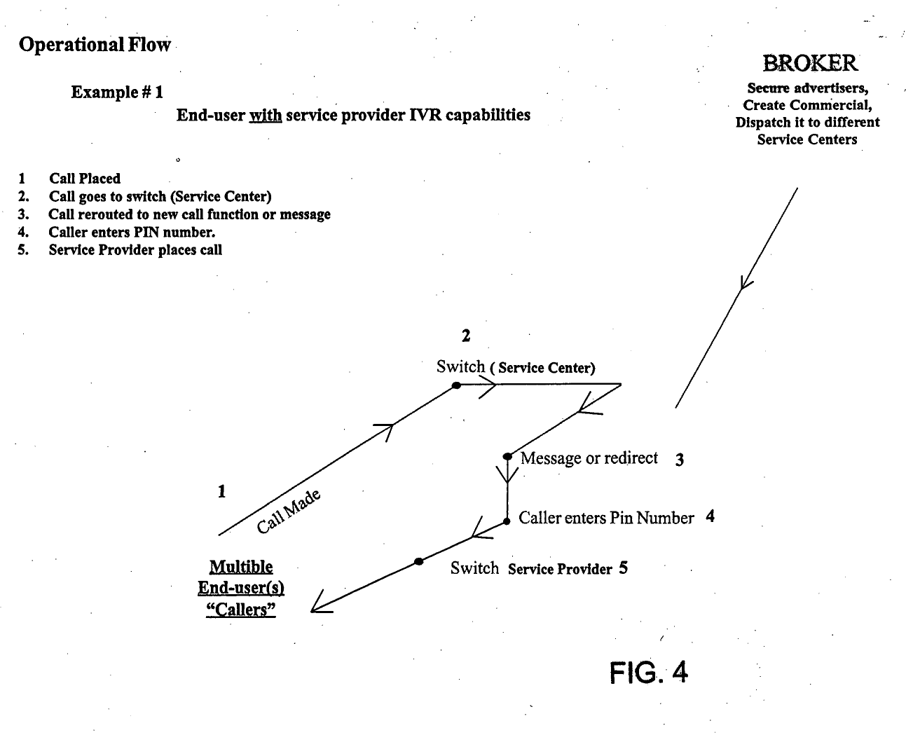

A mode of operation is illustrated by FIG. 4, a diagram of operational flow of end-user service provider with IVR capabilities and employs the following order: first the call is placed to access the system (by dialing, for example) and the call goes to a switch at a Call Center. Then the call is rerouted to a new call function or to present the particular message. Next, the caller optionally enters a PIN number, and the service provider places the call.

In the upper right corner, the function of the broker is illustrated, wherein the broker will secure advertisers, create commercials (that is, the ads or messages), will dispatch the commercials to different service centers (those centers that will actually play the message when the call is made).

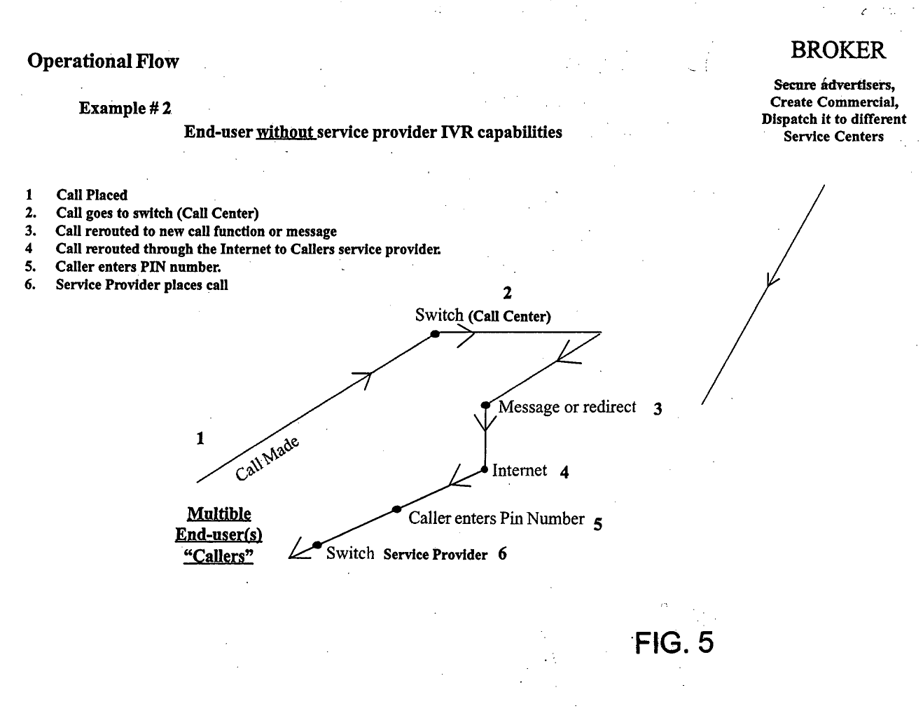

FIG. 5 illustrates another example of operational flow, of end-user service provider without IVR capabilities, using voice over IP (VOIP) on the internet. In this example, the call is placed to access the system (by dialing, for example) and the call goes to a switch at a Call Center. Then the call is rerouted to a new call function or to present the particular message. In this mode, now the call is rerouted through the Internet to the caller's service provider, and then the caller enters a PIN number, and the service provider places the call.

Again, illustrated in the upper right corner is the function of the broker, securing advertisers, creating commercials (that is, the ads or messages), and dispatching the commercials to different service centers (those centers that will actually play the message when the call is made.

The “with IVR” mode is employed for functions other than prepaid phone card uses, whereas the “without IVR” mode can be employed with prepaid phone cards, to provide a different routing that can allow use of lower cost access through the Internet, and allows use with service providers who do not have an IVR system.

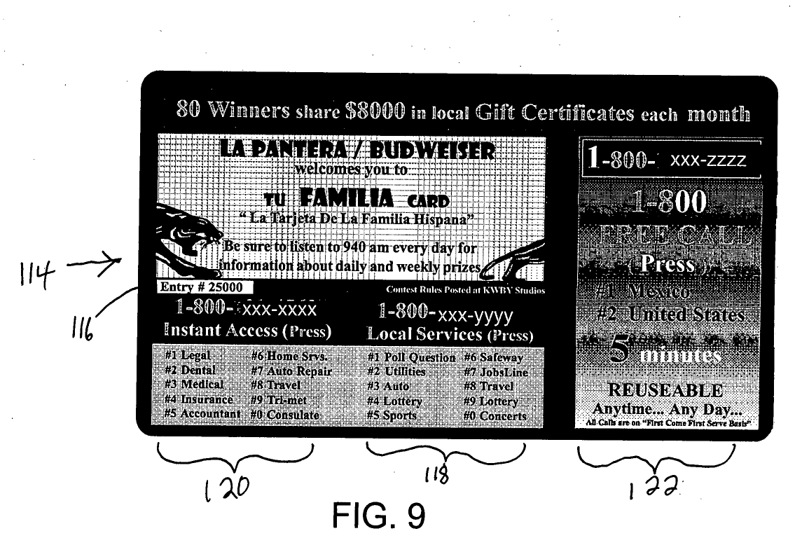

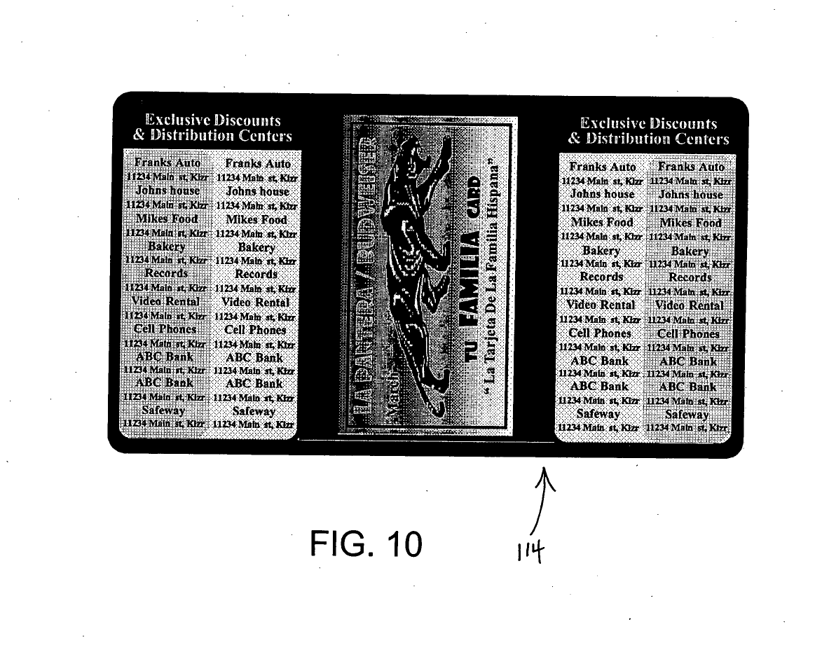

Referring to FIG. 9 and FIG. 10, which are view of a card employed in connection with a presently preferred embodiment of the invention, the card 114 may have a unique number 116 thereon (#25000 in the illustrated card) and includes information about prizes (“80 Winners share $8000 in local Gift Certificates each months”). The card is distributed by or on behalf of an advertiser, in the illustrated case the advertiser or sponsor is a radio station, and the card includes a message encouraging persons to listen to the radio station for information about prizes.

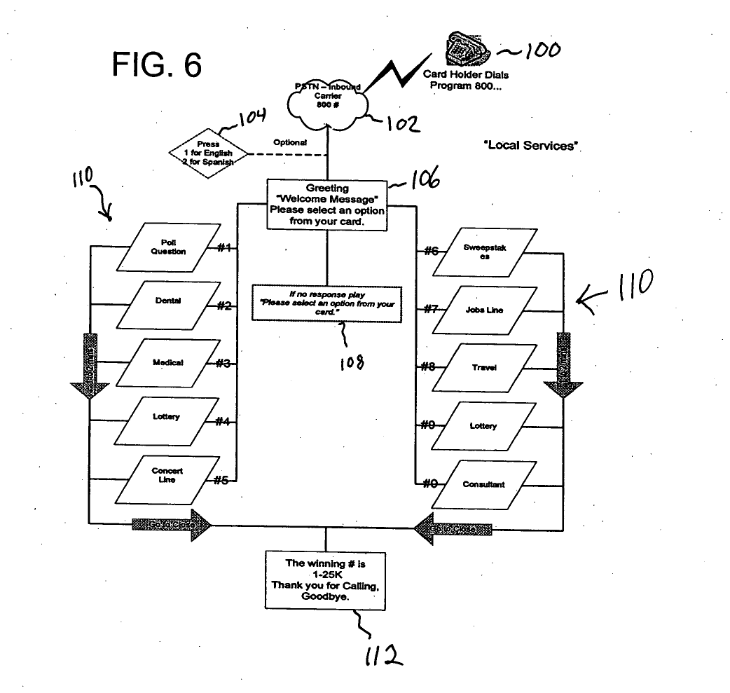

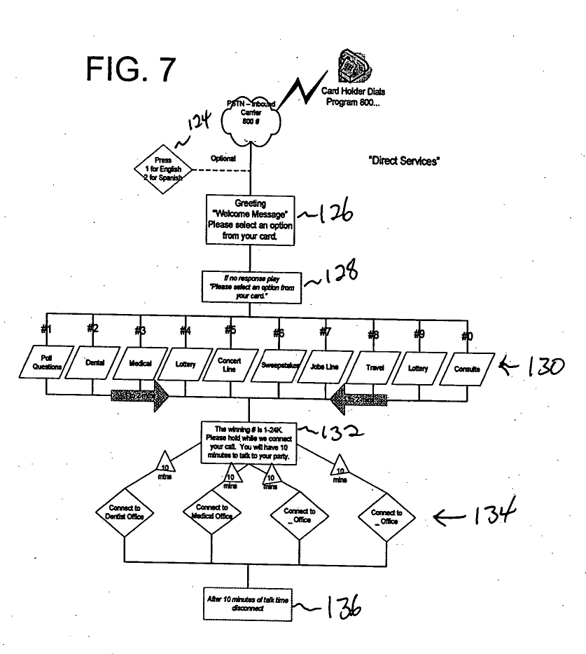

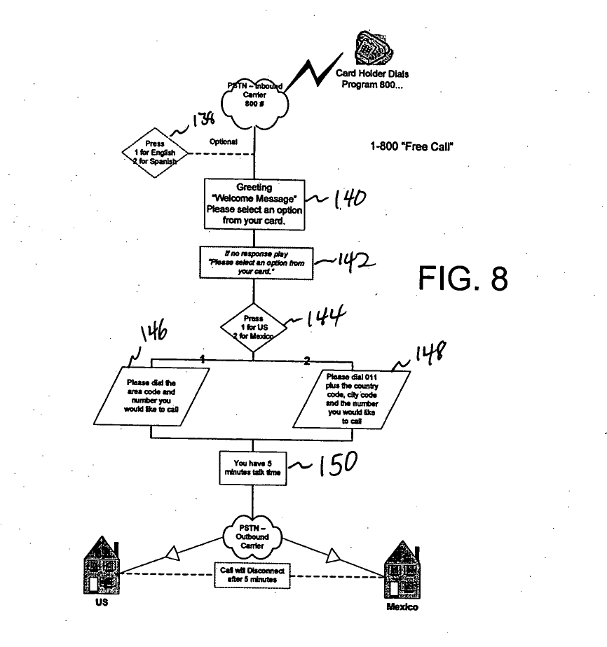

The card includes 3 regions 118, 120 and 122. Region 118 includes “Local Services” information numbers and a toll free number to call (1-800-xxx-yyy). Calling that access number will connect the user to the system discussed hereinbelow with reference to FIG. 6. Region 120 includes an “instant access” number, 1-800-xxx-xxxx, and includes a number of options for access to specific topics or services. The steps in accordance with this option are discussed herein with reference to FIG. 7. The card further includes a free call option in region 122, wherein the user calls a toll free number (1-800-xxx-zzzz) and is allowed to make a free telephone call of a certain duration (5 minutes in the illustrated embodiment). This particular operation is discussed with reference to FIG. 8. The reverse side of the card (FIG. 10) includes additional advertising, and may include date information (“March” in the illustrated version) to indicate a valid time period or distribution date of the card.

Referring to FIG. 6, a flow chart of a presently preferred embodiment of the system and method, in the case of a card holder using portion 118 of the card and dialing the number thereon, the card holder dials the telephone number which may be on the card and which is suitably a toll free number (“800 number” indicating a toll free number, although the number may not necessarily have 800 in it) (100). The call is placed via a Public Switched Telephone Network (PSTN) 800 number (102) at which point an optional selection of language in which to proceed may be presented (“press 1 for English, 2 for Spanish”, etc.) (block 104). A greeting is played at block 106, which may include a welcome message and an advertisement or other information. The caller is then directed to select an option. In optional step 108, if the caller does not select an option within a time period, another message may be played asking the caller to select an option.

In the illustrated embodiment, 10 separate options 110 are shown, although this number is not a requirement, and include a poll question, where the user can respond to polls, dental and medical options, where the user can hear dental or medical information. A lottery option may include information about winning lottery numbers, a concert line option will provide access to concert/movie/other entertainment schedules. A sweepstakes option allows entry into sweepstakes or contests, while a jobs line option will provide employment information. Travel option provides access to travel information, while a consultant option allows access to some type of consultant. Typically the various options are 1 to 2 minutes, and suitably can comprise advertising for these various services (or in the case of a poll question, an interactive poll to obtain public opinion). After completion of the message the process continues to block 112, wherein a “winning number” is presented to the consumer, and a closing message is played followed by disconnection of the call.

The “winning number” is presented as an enticement for the consumer to access the system and to listen to the advertising, as the consumer has been made aware that there is a number to be presented and if the consumer has that number, the consumer can win some type of prize.

Referring to FIG. 7, a flow chart of the steps performed when the user dials the access number (1-800-xxx-xxxx) in region 120 of the card of FIG. 9, as in FIG. 6, the user dials, is connected via the public switched telephone network, and is presented (optional) the choice of language (step 124). A greeting/welcome message is played (step 126). The user is asked to select an option, which can correspond to the options printed on the card for access to specific services. An optional second message may be played (128) if the user does not select an option within a time period.

After the option is selected, the process branches to one of the selected steps 130 corresponding to the user's selection, and an advertisement of 1 to 2 minutes length in the illustrated embodiment is played. Then, in step 132, a winning number (which corresponds to the drawing or sweepstakes number 116 on the card) is played. The user is now connected (134) to the specific service that was selected, which may comprise a dental office, a medical office, or some other service provider, and a free call of a certain length (10 minutes in the illustrated embodiment) is provided, wherein the user can converse with the office to which they have been connected. After the 10 minute (or other) talk time period has passed, the call is disconnected (block 136) if it is still in process.

The system can be implemented as a free call system, where the consumer dials a toll free access number in region 122 of the card of FIG. 9.

In this configuration, with reference to FIG. 8, the user makes the call via the PSTN, is optionally presented with a language selection choice (block 138) to choose in which language further information is presented, and then hears a greeting and advertisement (block 140) and is asked to select an option (in the illustrated embodiment, the options are for a free telephone call to Mexico (#1) or to the United States (#2). These are merely examples, and additional options or different options may be provided. If the user does not timely select an option another message (block 142) may be played to again prompt for a selection. In the illustrated embodiment, the user then selects either option 1 or 2 (block 144) and is then instructed how to dial the telephone number (block 146 or 148). After dialing, the user is informed in steop 150 that there will be 5 minutes (or whatever the specific time amount allowed by the implementation) period to talk. The call is directed through a PSTN outbound carrier, and will disconnect after the time period. An optional time reminder may be played to the user as the end of the time limit approaches. Thus, in exchange for listening to an advertisement, the consumer is given a free telephone call access. This can allow focused advertisings, for example where calls are allowed to other countries, and the advertising may be directed to products or services that consumers calling the particular country or region might be interested in.

The system and method provides benefits to different types of entities. For example, for suppliers, the system can provide increased card sales, free branding advertising, commission revenues, increase of repeat business and increased card longevity. Distributors and merchants may be provided with all the above aspects plus increased recharges of cards.. Meanwhile, the end-user is provided with multiple services, special offers and values, contests and savings.

Thus, in accordance with the system and method, and improved advertising system is provided, whereby a targeted ad can be presented to a consumer with an incentive for the consumer to listen to the advertising.

While preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. An advertising presentation system for use in connection with accounts, comprising:
an advertising server for presenting an advertisement to an account user in conjunction with access to the account or in conjunction with completion of a transaction.

2. The system according to claim 1, wherein said advertisement is presented prior to access to the account or prior to completion of the transaction.

3. The system according to claim 1, wherein the account user is a prepaid telephone card holder.

4. The system according to claim 3, wherein said advertisement is presented prior to completion of a telephone call the user is attempting to make by use of the prepaid telephone card.

5. A method of providing advertising, comprising:
providing an account user with a manner of accessing an account;
presenting an advertisement to the user when the user attempts to access the account.

6. The method according to claim 5, wherein the presenting step presents the advertisement to the user before allowing access to the account.

7. The method according to claim 5, wherein the account is a telephone calling account.

8. The method according to claim 5, wherein the account is a telephone calling account and the manner of access is a prepaid calling card.

9. A calling card, comprising:
plural cards presented as a unit, wherein at least one of said cards comprises a calling card, and at least one comprises a services access card.

10. The calling card according to claim 10, wherein the number of said plural cards is three.

11. A method of providing advertising and telecommunication services to a consumer, comprising:
presenting an advertisement to the consumer; and
offering the consumer a service free of charge in exchange for the consumer having listened to or observed the advertisement.

12. The method according to claim 11, wherein the service comprises a telephone call.

13. The method according to claim 12, wherein the telephone call is not allowed to exceed a timed duration.

14. The method according to claim 12, wherein the telephone call is allowed to be placed to a number desired by the customer to any valid phone number.

15. The method according to claim 11, wherein the advertisement is an audio advertisement.

16. The method according to claim 11, wherein the advertisement is an audio-visual advertisement.

17. The method according to claim 11, wherein the advertisement is a visual advertisement.

18. The method according to claim 11, wherein the service comprises access to a computer network.

19. The method according to claim 11, wherein the service comprises access to an email service.
